(19) United States
(12) Patent Application Publication
(10) Pub. No.: US 2006/0212495 A1
(43) Pub. Date: Sep. 21, 2006

(54) Method and system for storing data into a database

(76) Inventors: Mikihiko Tokunaga, Fujisawa (JP); Norihiro Hara, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/347,266

(22) Filed: Feb. 6, 2006

(30) Foreign Application Priority Data
Dec. 2, 2005 (JP) 2005-348572
Mar. 18, 2005 (JP) 2005-079836

(51) Int. Cl. G06F 17/30

(52) U.S. Cl. 707/204

(57) ABSTRACT

An information processing apparatus divides a database table into separate tables according to a table division condition, correlates the separate tables to areas as logical storage devices, correlates the areas to storage devices, detects a predetermined area whose use amount is equal to or exceeds a predetermined value, assures an empty storage device having an empty capacity, and adds the empty storage device to a storage device correlated to the predetermined area.

This application claims priorities from Japanese applications JP2005-348572 filed on Dec. 2, 2005, JP2005-079836 filed on Mar. 18, 2005, the contents of which are hereby incorporated by reference into this application.

### BACKGROUND OF THE INVENTION

This invention relates to a method and a system for storing data into a database.

Documents which have been stored on sheets of paper are now stored as electronic data which can be processed by a computer. This saves the space which has been occupied by the documents stored on the sheets of paper and facilitates search of the documents.

It should be noted that there is a document which should be stored for a long period of time such as several tens of years as an evidence. Such a document should be stored as electronic data for a long period of time as the computerization proceeds. Storing electronic data for a long period of time is being made into a law. For example, it is stipulated in the law concerning a special case such as a method for storing national tax book documents created by using a computer.(Mar. 31, 1998, law No. 25).

The electronic data is normally stored in the table format handled by the RDB (relational database) (JP-A-2000-163293 for example). The table format basically contains columns (fields) defined firstly as input items and the number of rows (records) is increased as the time elapses. Accordingly, the table contains a data amount which increases as the time elapses and there is a case that the data cannot be stored in a single storage.

Then, the table-formatted data is divided into separate tables, which are stored in separate storage devices, thereby storing a gigantic table of data. Here, when dividing a table into separate tables, it is possible to use a key range division or a Hash division using the date of the record or the record identifier as a key. It should be noted that the records are normally constructed as write-once data.

However, it has been difficult to decide the size of the separate tables. The fields and the records in the table may increase in the future. It is difficult to predict the increase degree and plan the storage capacity for storing the separate tables for a long period of time such as several tens of years.

### SUMMARY OF INVENTION

It is therefor an object of the invention to improve the operation when a table is distributed to be stored in a plurality of storage devices.

Another object of this invention is to effectively manage the data stored in the plurality of storage devices.

In order to achieve the aforementioned objects, this invention provides a storing-into-database method for storing a database table into a storage device as a physical storage medium, wherein an information processing apparatus executes: a step of dividing the database table into separate tables according to a table division condition, correlating the separate tables with areas as logical storage areas, and correlating the areas with the storage devices, a step of detecting a predetermined area whose use amount is equal to or exceeds a predetermined value, a step of assuring an empty storage device having an empty capacity, and a step of adding the empty storage device to the storage device correlated to the predetermined area. The other means will be detailed later.

With the aforementioned configuration, it is possible to eliminate the need of design concerning a long-term DB capacity in the initial building-up and allocation of a storage (area) prepared when required is realized. Without planning the storage capacity at the initial stage, it is possible to store a gigantic table by distributing it into a plurality of storage devices. Thus, it is possible to promote the effective resource throw and facilitate the operation.

According to this invention, a table can be divided into a plurality of parts which are stored in separate storage device.

When storing electronic data such as mails and contracts for a long period of time, it is possible to build up at first a server and storage device with the minimum configuration and then extend the system according to a plan as the data amount increases.

Other objects, features and advantages of the invention will become apparent from the following description of the embodiments of the invention taken in conjunction with the accompanying drawings.

### BRIEF DESCRIPTION OF THE DRAWINGS

FIG. 1 explains a model of a method for storing a table.

FIG. 2 explains a countermeasure performed when the area is full.

FIG. 3 shows configuration of a computer system.

FIG. 4 shows hardware configuration of the computer system.

FIGS. SA and 5B show configuration of a table division definition table.

FIG. 6 shows configuration of an area information table.

FIG. 7 is a flowchart showing a countermeasure performed when the area is full.

FIG. 8 explains a countermeasure performed when the area is full.

FIG. 9 is another flowchart showing a countermeasure performed when the area is full.

FIG. 10 is a flowchart showing a data insert destination modification process.

FIG. 11 shows a configuration of a table modified by the data insert destination modification process.

FIG. 12 shows hardware configuration of the computer system.

FIG. 13 explains a logical storage area of the storage system.

FIG. 14 shows a RAID group management table.

FIG. 15 shows an LU management table.

FIG. 16 is a diagram showing static performance information.

FIG. 17 is a diagram showing dynamic performance information.

FIG. 18 is a flowchart showing a process of a storage allocation unit.

FIG. 19 shows a relationship between the logical unit, the logical device, and the affect degree.

FIG. 20 is a flowchart showing a process of a data reallocation unit.

### DETAILED DESCRIPTION OF THE EMBODIMENTS

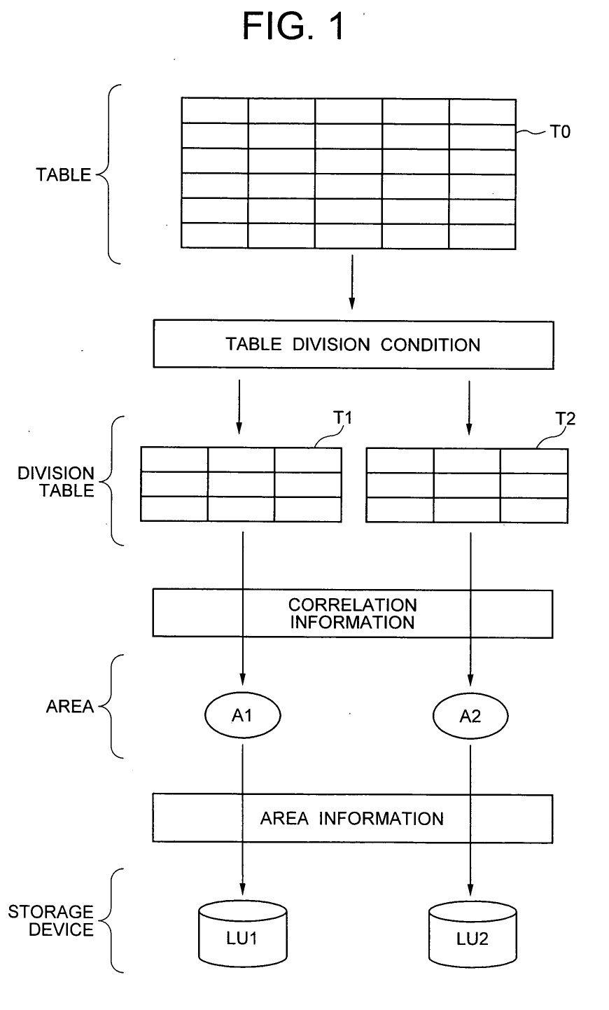

Description will now be directed to a computer system according to a first embodiment of this invention with reference to the attached drawings. Firstly, explanation will be given on the configuration of the computer system according to the present embodiment by referring to FIG. 1 to FIG. 6.

FIG. 1 explains a model of a method for storing a table. A table T0 is electronic data to be stored for a long period of time. The data in table T0 is write-once data which is not rewritten, i.e., once a value is inputted, the value is used only for read. It should be noted that the cell values in table T0 are added as the time elapses and not all cells are filled with the values at the beginning. The table division condition is a condition to divide the table T0 into a separate table T1 and a separate table T2. Thus, one gigantic table T0 is divided into a size which can easily be stored in a storage device.

The correlation information correlates the separate tables (separate table T1 and separate table T2) to areas (area A1 and area A2). For example, when the separate table T1 is correlated to the area Al, it means that the separate table T1 is stored in the area Al. It should be noted that the area is a unit for operating data such as backup and garbage collection, i.e., a logical data storage device which is managed by a program (such as a database management system) managing the data. For each data, data allowance capacity (for example, up to 100 G Bytes of data can be stored) and the current data use capacity (for example, 80 G Bytes of data are currently stored) are defined and managed.

The area information is information for correlating the areas (area A1 and area A2) to storage devices (LU1 and LU2). For example, when the area A1 is correlated to LU1, it means that the data in the area A1 is stored in LU1. The storage device is a physical storage device for storing data. For example, the storage device is constructed as an HDD (Hard Disk Drive). Moreover, the storage device may have a network interface for connection to a network such as a SAN (Storage Area Network). Its specific configuration will be detailed later. In this embodiment, instead of correlating the separate tables directly to the storage devices, areas are used as intermediate layers.

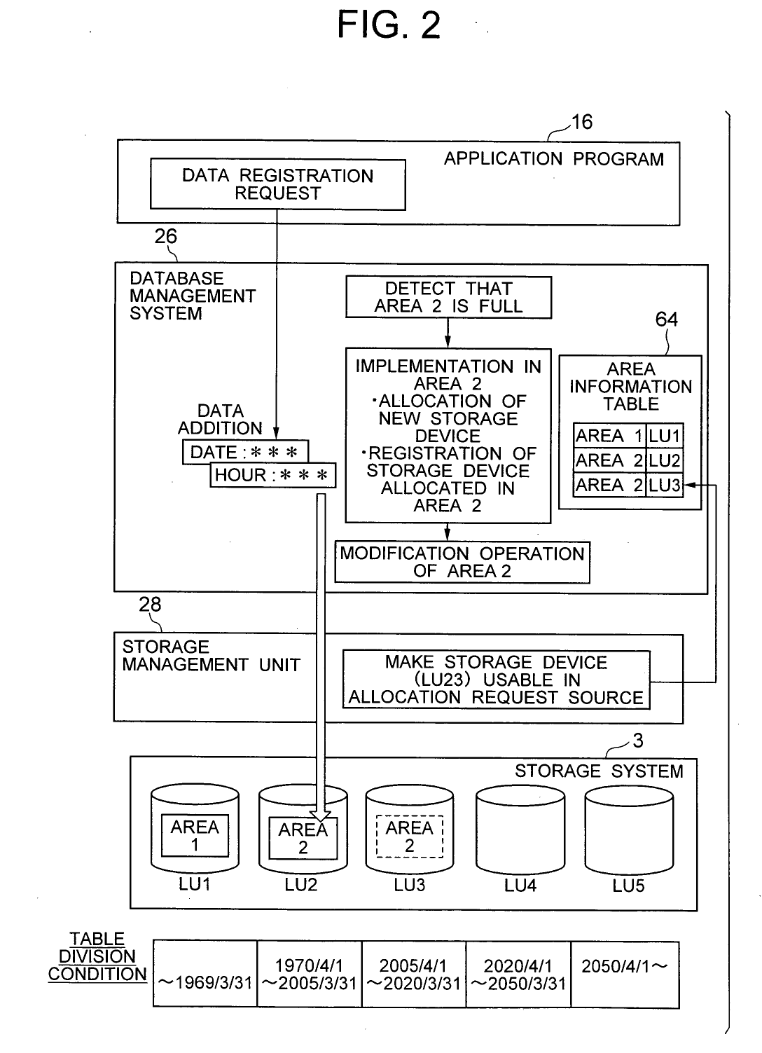

FIG. 2 explains a countermeasure performed when the area is full (the use amount of the data stored in the area is a predetermined value or above). It should be noted that the expression that “the area is full” is not limited to the case that the use ratio (current data use amount/data allowance capacity) is literally 100% in this embodiment. For example, when the use ratio (such as 90%) exceeding the use ratio (such as 85%) as a predetermined threshold value is the expression “the area is full” is used. Moreover, when data is to be stored in an area but the data cannot be stored because the empty capacity is insufficient, the expression “the area is full” is used.

FIG. 2 shows the method of the first embodiment in which the area which has become full is extended for writing new data. The area extension means to allocate a new storage unit to the existing area so as to increase the data allowance capacity. This eliminates the need of planning the data allowance capacity at the initial stage for each area and facilitates the operation of a long period of storage.

In other words, according to the method of the first embodiment, a plurality of areas are defined in advance but the actual storage devices are only defined without being allocated to all the areas. When the area to store currently new data has reached a predetermined use ratio, a new storage unit is allocated to the area for storing the existing data.

When a database management system 26 receives a data registration process request from an application program 16, it tries to write data into a storage system 3 via a storage management unit 28. However, when the database management system 26 detects that the area 2 into which the data is to be written is already full, it performs substantiation to the area 2. More specifically, it requests the storage management unit 28 to allocate a new storage unit and updates an area information table 64 so that the storage unit LU 3 acquired as a result is allocated in the existing area 2. The database management system 26 updates operation of the area 2.

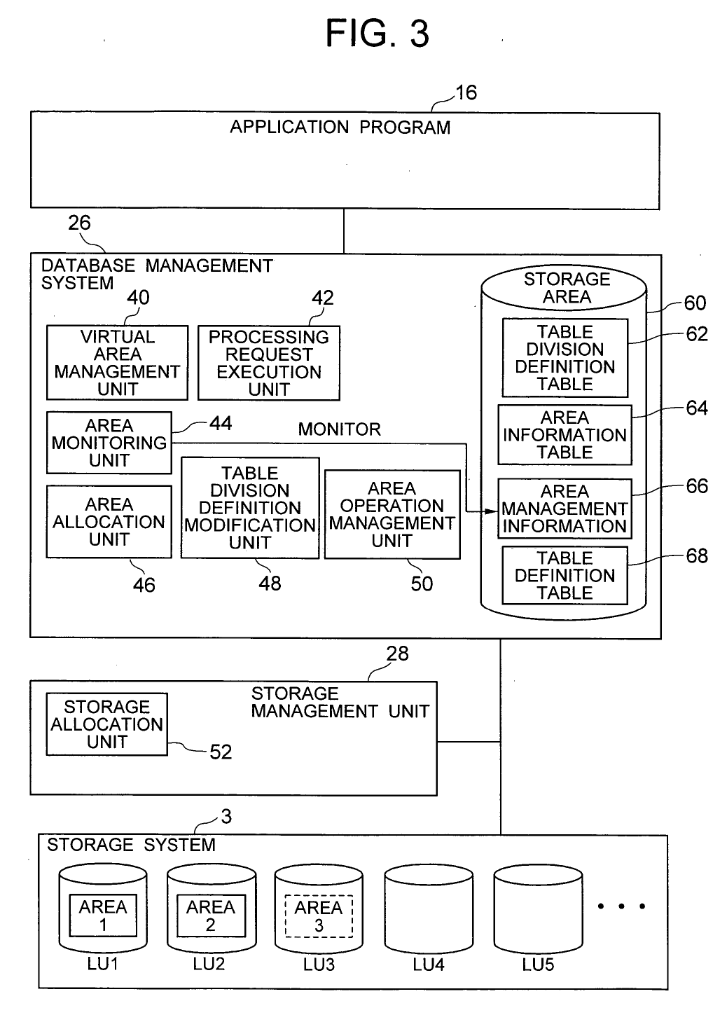

FIG. 3 shows functional blocks of a part of the computer system. The computer system includes an application program 16, a database management system 26, the storage management unit 28, and the storage system 3. The application program 16 is a program for requesting a data registration process.

The database management system 26 includes a storage area 60. The storage area 60 stores a table division definition table 62, an area information table 64, area management information 66, and table definition information 68. The table division definition table 62 stores the table division condition and the correlation information shown in FIG. 1. The area management information 66 is information indicating the area use ratio and the area into which write is currently performed (hereinafter, referred to as a current area). The table definition information 68 indicate table definition such as element names (family name, given name, address, etc.) of the columns (field) and data type of the cell value (integer type, etc.).

The database management system 26 includes an area monitoring unit 44 monitoring the area management information 66, a process request execution unit 42 for requesting a new storage device when the area full is detected by the area monitoring unit 44, and an area allocation unit 46 for allocating a new storage device acquired by the process request execution unit 42 to the area.

Furthermore, the database management system 26 includes a table division definition modification unit 48 for updating the table division definition of the table division definition table 62, a virtual area management unit 40 for updating the table division definition table 62, and an area operation management unit 50 for updating the area information table 64.

The storage management unit 28 includes a storage allocation unit 52 for allocating an empty storage device of the storage system according to a request from the process request execution unit 42. The storage system 3 manages the storage devices (LU1, LU2, . . . ) all at once and reads/writes data according to a request from the storage management unit 28.

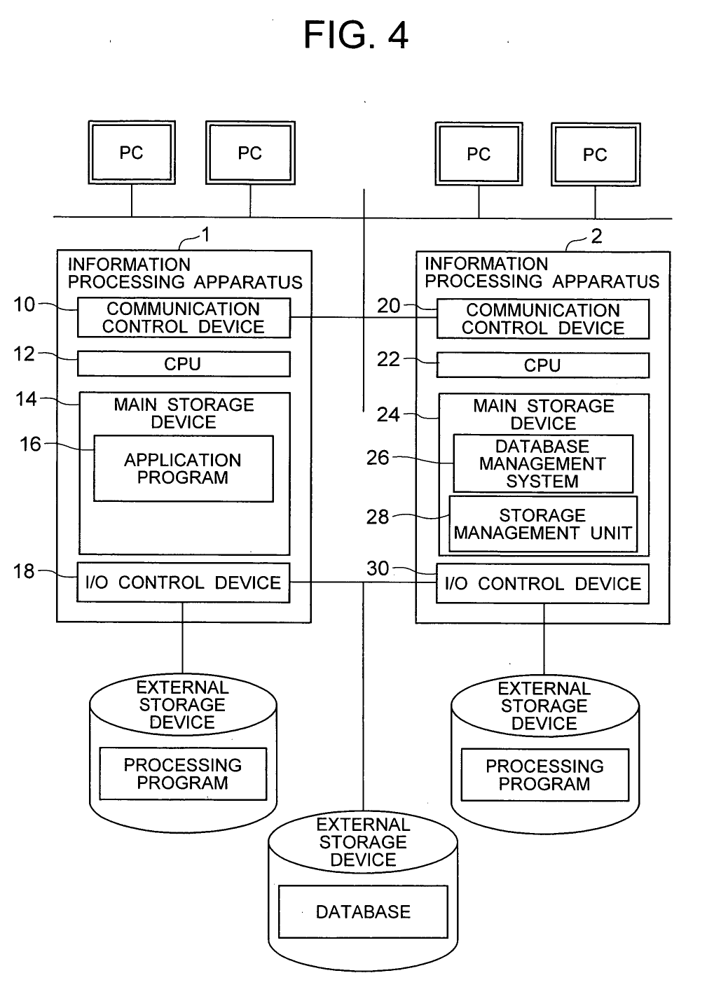

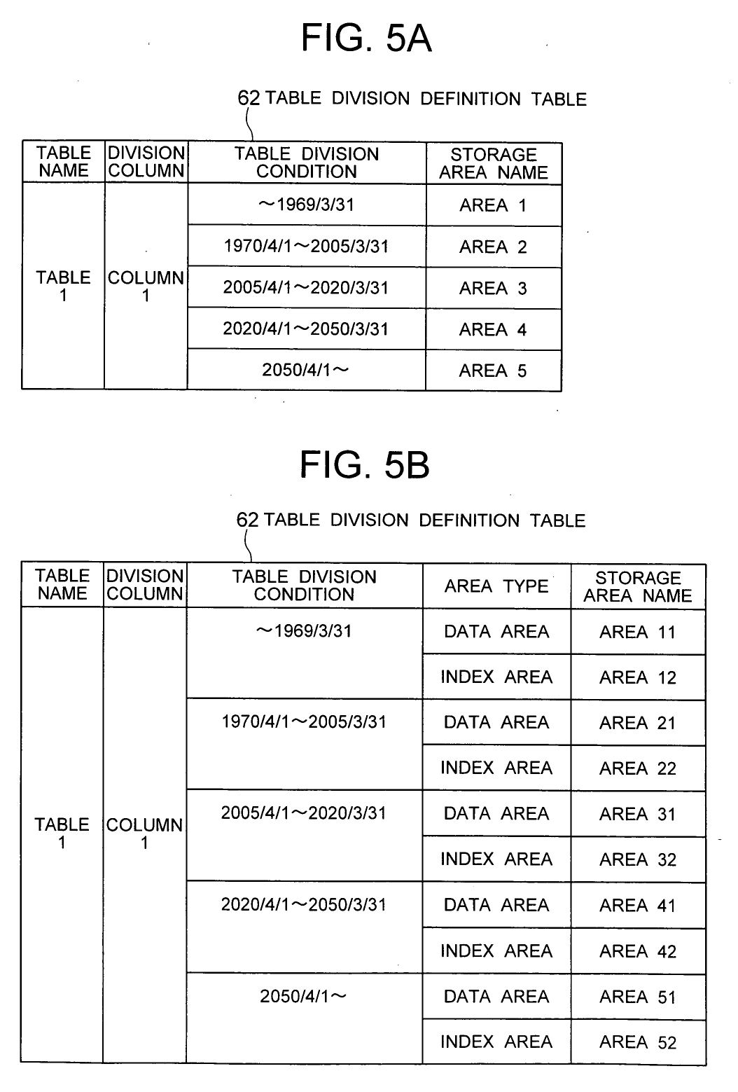

FIG. 4 shows hardware configuration of the computer system. The PC (Personal Computer) is a computer terminal for accessing the application program 16. The information processing apparatus 1 and the information processing apparatus 2 are configured as computers and connected to an external storage device for storing a processing program and a database via a USB (Universal Serial Bus) and Ethernet (registered trademark).

Firstly, the information processing apparatus 1 includes a communication control device 10, a CPU (Central Processing Unit) 12, a main storage device 14, and an I/O control device 18. The application program 16 has been read into the main storage device 14 and is executed by the CPU 12. On the other hand, the information processing apparatus 2 includes a communication control device 20, a CPU 22, a main storage device 24, and an I/O control device 30. The database management system 26 and the storage management unit 28 have been read into the main storage device 24 and are executed by the CPU 22.

FIG. 5A and FIG. 5B show an example of the table division definition table 62. FIG. 5A shows an example of the table division definition table 62 when the areas are all of the same type. As compared to FIG. 5A, FIG. 5B shows an example of the table division definition table having area types of different characteristics depending on the areas.

In FIG. 5A, the table name “Table 1” is divided into five separate tables by five table division conditions. For example, the separate table on the uppermost row includes only data having data date before Mar. 31, 1969 extracted from “Table 1”. The five separate tables have correspondence information indicated so that they are stored in five areas indicated by the corresponding storage device names. For example, the separate table in the uppermost row is stored in area 1.

Like FIG. 5A, in FIG. 5B. the table name “Table 1” is divided into five separate tables. It should be noted that different area types are allocated to the areas for storing the separate tables. The area type may be, for example, a data area-for storing data, an index area for effectively accessing the data, and an object area for indicating the data storage destination.

The data stored in the data area may be an integer type or a character type. The index stored in the index area may have, for example, a data structure of a balanced tree and when the data indicated has become old, the data may be erased because the use frequency becomes lower.

The index is means for accessing the data and it is not required unless high data access speed is required. For this, as the data itself becomes old and the access frequency becomes lower, the use frequency of the index also becomes smaller and the position of having the index itself is lost. Accordingly, the index correlated to old data becomes unnecessary and the index area containing the index is deleted. With this, the database management system 26 automatically modifies the access path so that the application program 16 accessing the index area will not use the index.

Thus, it is possible to reduce the storage capacity for the index area and the number of the areas to be managed and reduce the management cost.

Moreover, for the old index area, it is possible to switch to operation not acquiring backup. When an error has occurred in the index area, the operation is switched to re-creation of the index from the data. Alternatively, it is also possible to automatically modify the access path not to use the index. This backup-less operation can realize simplification of the operation.

In an SQL (Structured Query Language) 99, the data stored in an object area is normally a LOB (Large Object) containing data in the order of Giga Bytes. The LOB is further classified into a BLOB (Binary Large Object) for storing binary data such as audio data and image data, a CLOB (Character Large Object) for storing character data, and the like. It should be noted that the BLOB and the CLOB may be handled as the same area type or different area types.

The access frequency to the LOB data is essentially not large and the update itself occurs not often. Furthermore, as the time elapses from the data registration, the access frequency is lowered or the access scarcely occurs. As compared to the data main body, the LOB data has a lower access frequency and accordingly even if the accessing of the LOB data takes time, the functional requirement is satisfied only if handling is enabled. For this, when the data itself has become old, it is effective to modify the operation to switch the LOB data in the area to compressed storage. By this compressed storage, it is possible to reduce the storage capacity for the object area.

Moreover, for the old index area, it is possible to switch to the operation where the backup is performed only once. After that, the backup acquisition is not performed, By this backup simplification, it is possible to realize simplification of the operation.

The area type is referenced when deciding to which storage device the area is correlated. For example, when the data date of the data to be accessed by the index area is old, the frequency of referencing the index becomes lower and the index area is correlated to a low-performance storage device.

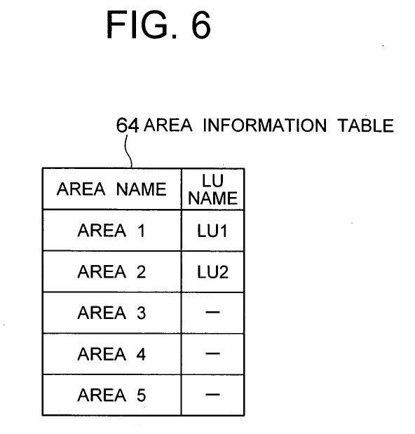

FIG. 6 shows an example of configuration of the area information table 64. For example, the data in the area 1 is stored in LU1. It should be noted that an area having “-” for the LU name is an area in which the storage destination LU is not determined.

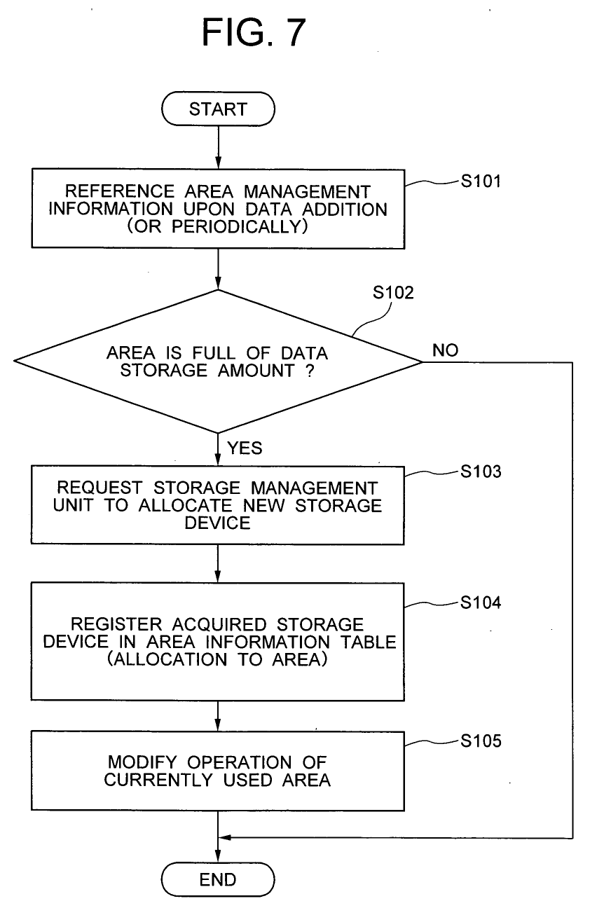

Thus, explanation has been given on the configuration of the computer system. Next, explanation will be given on the process of the operation of the computer system according to the present embodiment with reference to FIG. 1 to FIG. 6 according to FIG. 7.

FIG. 7 is a flowchart showing the countermeasure performed when the area is full.

Firstly, the area monitoring unit 44 references the area management information 66 when adding data (or periodically) (S101). It should be noted that if shortage of data capacity is detected upon addition of data, it takes time to allocate a new storage device and data addition should wait. To cope with this, for example, when the data addition frequency is low such as in the night time, the area management information 66 is periodically referenced, thereby suppressing the data addition waiting for allocation of a new storage device.

Next, the process request execution unit 42 judges whether the data storage amount in the area has become full (S102). When the data storage amount is not full (No in S102 step), the process is terminated. On the other hand, when the data storage amount is full (YES in S102 step), the process request execution unit 42 requests the storage management unit 28 to allocate a new storage device (S103). It should be noted that the request message always contains a data amount to be requested. It should be noted that a case when no data amount to be requested is contained will be detailed later. Furthermore, the request message may contain requested storage characteristic (high-speed disc, reliable disc, etc.) as additional information. The storage management unit 28 receives the request and allocates a new storage device.

Furthermore, the area allocation unit 46 registers the acquired storage device in the area information table 64 (allocation to the area) (S104). Here, the table division condition is not modified and the acquired storage device is allocated to the existing area.

The area operation management unit 50 modifies the operation of the area currently used (S105). The modification of the operation is performed, for example, by considering the data life cycle. More specifically, data having an old data date is accessed not frequently and it is sufficient that it is stored in an inexpensive storage device (low-speed storage device, etc.). Accordingly, the area operation management unit 50 moves the data having the old date from an expensive storage device to an inexpensive storage device.

Moreover, the data having an old data date normally has a lower data importance as compared to new data. In this case, the reliability improvement process of old data (backup, duplication, etc.) may be performed less often than the new data. Furthermore, for the old data, the reliability improvement process may not be performed.

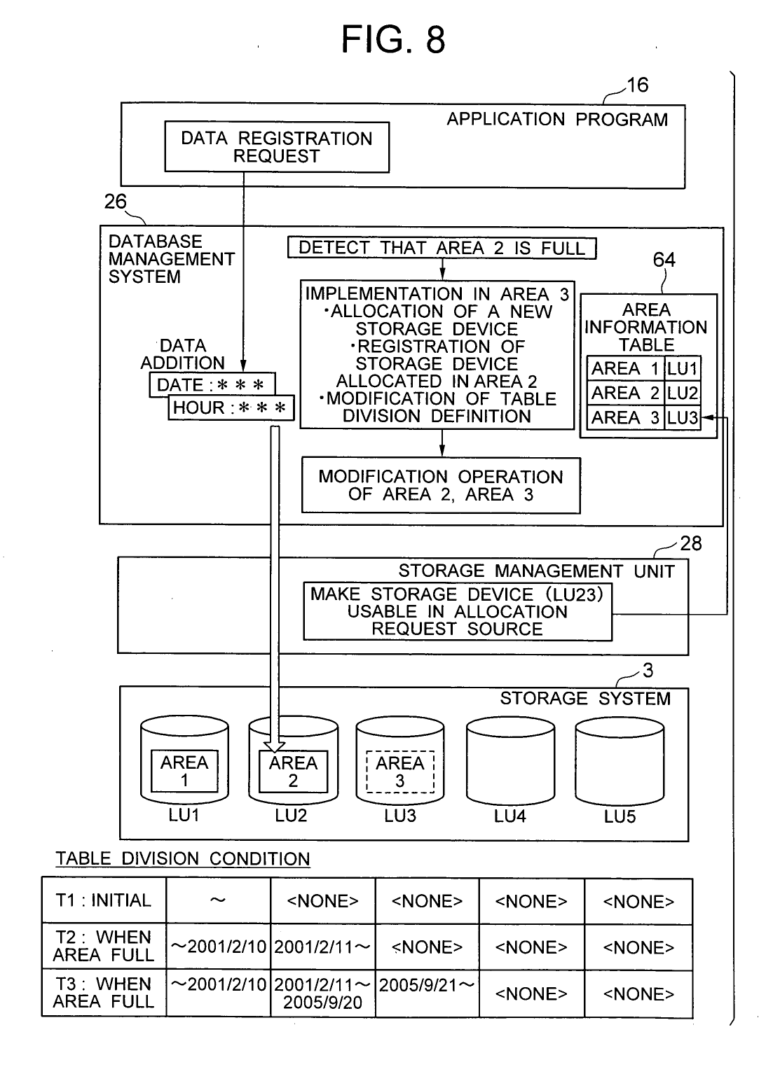

Hereinafter, explanation will be given on the computer system according to a second embodiment of this invention with reference to the attached drawings. FIG. 8 explains a counter measure performed when the area is full.

In the method of the second embodiment shown in FIG. 8, new data is written into a separate area different from the area which has become full. That is, by allocating a new storage device to a new area to be used, data allowance capacity is increased. More specifically, data is stored in a predetermined amount of area group and the key at the moment when the area has become full is set as a key range division value of the table division condition and data afterward is stored in a new area. Thus, for each area, there is no need of planning a data allowance capacity at the initial stage and it becomes easier to perform operation of a long period of storage.

When the database management system 26 receives a data registration process request from the application program 16, it tries to write data into the storage system 3 via the storage management unit 28. However, when the database management system 26 detects that the area 2 as a write object is already full, it performs implementation of the area 3. More specifically, the database management system 26 requests the storage management unit 28 to allocate a new storage device and updates the area information table 64 so as to allocate the storage LU3 obtained as a result to the new area 3 to be used. The database management system 26 modifies the operation of the area 2 and the area 3.

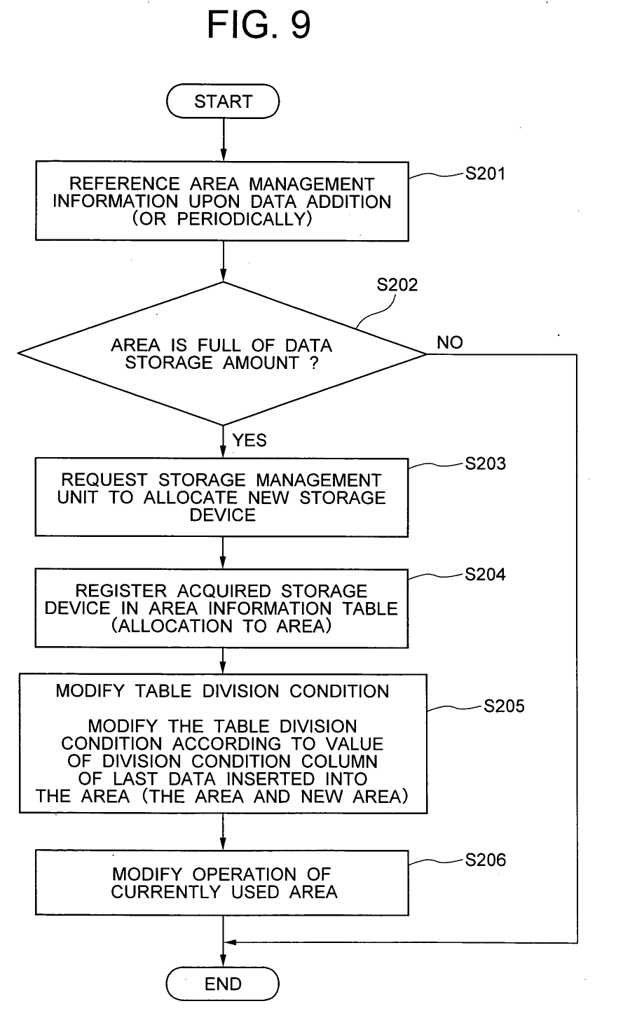

FIG. 9 is a flowchart indicating the countermeasure performed when the area is full.

Firstly, S201 to S203 are the same operations as S101 to S103 of FIG. 7. The area allocation unit 46 registers the acquired storage device on the area information table 64 (allocation to the area) (S204). As compared to step S104 where the acquired storage device is allocated to an existing area, S204 allocates the acquired storage device to a new area to be used.

Furthermore, the table division definition modification unit 48 defines the new area to be used in S204 by modifying the table division condition (S205). More specifically, the table division definition modification unit 48 modifies the table division condition (the area and the new area) according to a value of the last division condition string of the data inserted to the area. The area operation management unit 50 modifies the operation of the currently used area (S206).

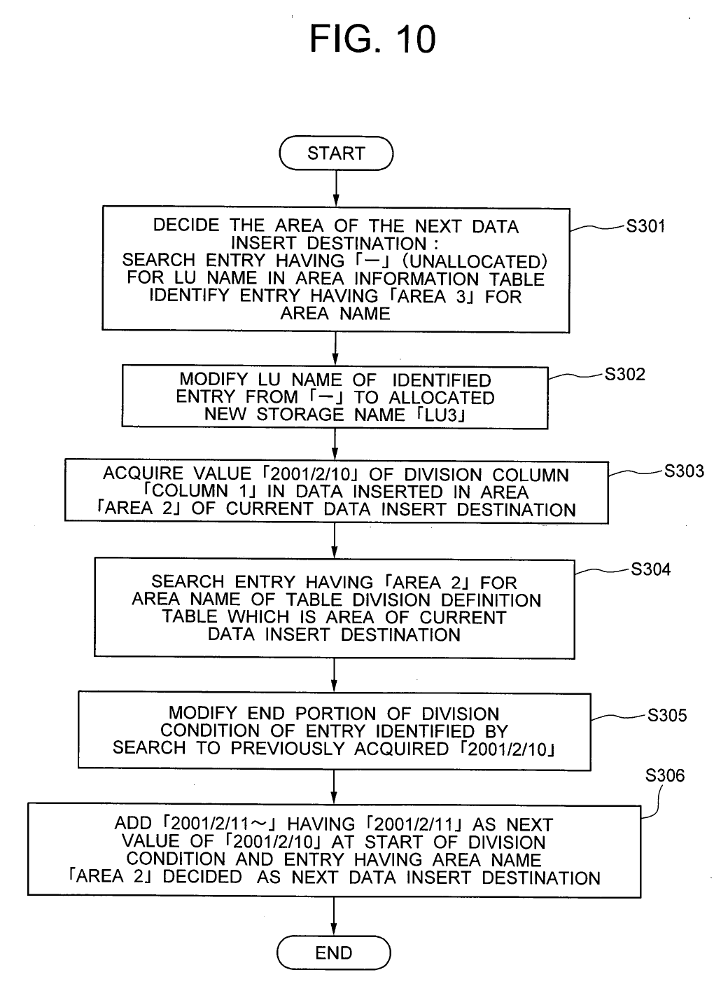

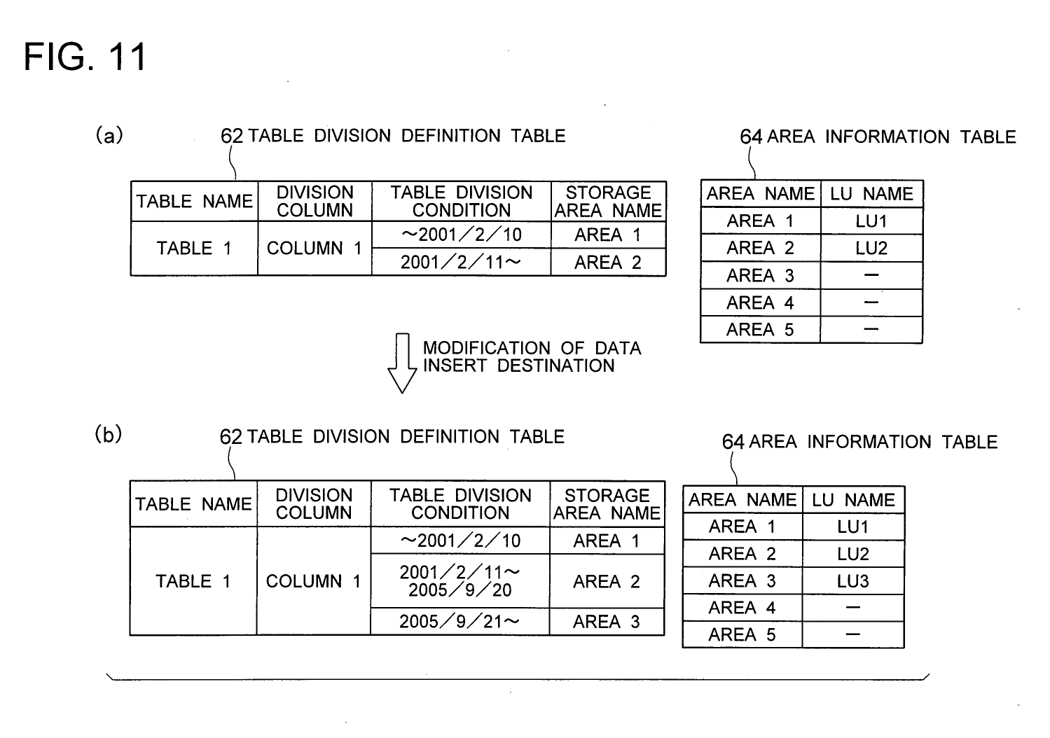

FIG. 10 is a flowchart showing an example of modification process of the table division condition shown in FIG. 205 (data insert destination modification process). FIG. 11A indicates the contents of the table before the process and FIG. 11B indicates the contents of the table after the process.

Firstly, the table division definition modification unit 48 decides an area as the next data insert destination (S301). That is, the table division definition modification unit 48 searches for an entry having “-” for the LU name (not allocated) of the area information table 64 and specifies an entry having an area name “area 3”.

Next, the table division definition modification unit 48 modifies the LU name of the specified entry from “-” to the allocated new storage device name “LU3” (S302). The table division definition modification unit 48 acquires the value “2001/2/10” of the division column “column 1” in the data inserted into the current data insert destination area “area 2” (S303). Furthermore, the table division definition modification unit 48 searches the entry having the area name of the table division definition table 62 which is the current data insert destination area “area 2” (S304). The table division definition modification unit 48 modifies the end portion of the division condition of the entry identified by the search to “2001/2/10” which has been acquired previously (S305).

Furthermore, the table division definition modification unit 48 adds an entry to the table division definition table 62 (S306). It should be noted that the entry added is an entry “2001/2/11-” having the value “2001/2/11” next to “2001/2/10” at the start portion of the division condition and the area name “area 2” decided as the next data insert destination.

This invention thus far explained can be modifies without departing from the spirit of the inventions as described below.

The storage medium constituting the storage device may be, for example, a flash memory, an optical disc such as a DVD (Digital Versatile Disc), an MO (Magneto-Optical disc), and a magnetic disk such as an HD (hard disk).

Moreover, a microfilm which has been used for a long-period storage is used for writing analog data such as drawings. By providing a D/A conversion (during write) and an A/D conversion (during read) mechanism in the storage device according to the present embodiment, it is possible to utilize the microfilm.

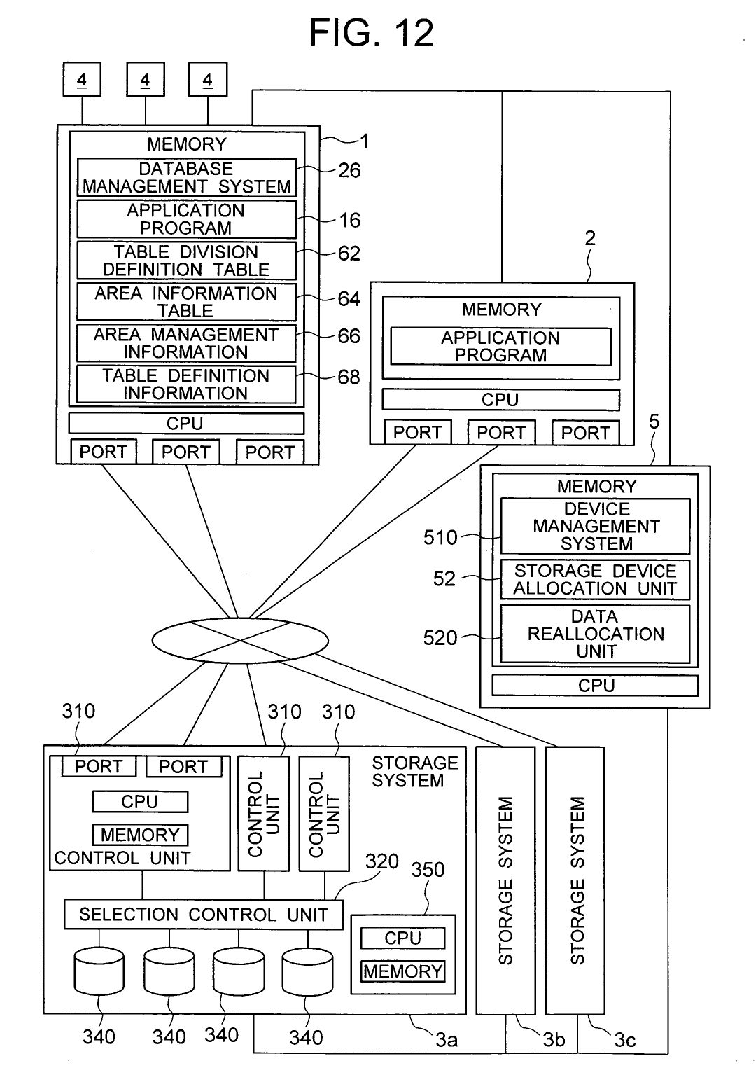

FIG. 12 shows another hardware configuration of the computer system. It should be noted that among the reference symbols in the figure, those which have been explained are denoted by the same reference symbols.

The computer system includes information processing apparatuses 1, 2, a plurality of storage systems 3 (3c, 3b, 3c), a plurality of terminals 4, and a management server 5. The information processing apparatuses 1, 2 and the storage systems 3 are connected to one another via a network. Moreover, the terminals 4 and the information processing apparatuses 1, 2 are connected to one another via a network. Furthermore, the information processing apparatuses 1, 2 and the storage systems 3, and the management server are also connected to one another via a network.

Here, three networks are used. These networks may use the same communication protocol or different communication protocols. The network may be, for example, a LAN (Local Area Network), SAN, the Internet, a dedicated line, and the like.

When the computer system is an open system, for example, data transmission is performed according to protocols such as TCP/IP (Transmission Control Protocol/Internet Protocol), FCP (Fibre Channel Protocol), and iSCSI (internet Small Computer System Interface).

When the computer system is a main frame system, for example, data transmission is performed according to the communication protocols such as FICON (Fibre Connection: registered trademark), ESCON (Enterprise System Connection: registered trademark), ACONARC (Advanced Connection Architecture: registered trademark), and FIBARC (Fibre Connection Architecture: registered trademark).

In such a configuration, data write from the information processing apparatuses 1, 2 to the storage systems 3 and data read thereof are performed between the information processing apparatuses 1, 2 and the storage systems 3 via the network.

The information processing apparatuses 1, 2 have a memory for storing a program and data, a CPU for executing the program stored in the memory, an interface for performing communication with the storage systems 3 (indicated as a port in the figure), and interface (not depicted) for performing communications with the terminals 4 or the management server 5.

The memory of the information processing apparatus 1 contains the application program 16 already explained, a program for realizing the database management system 26, the table division definition table 62 already explained, an area information table 64, area management information 66, and table definition information 68. The CPU reads out the application program 16 and a program of the database management system 26 from the memory and executes the process already explained. Moreover, the memory of the information processing apparatus 2 contains another application program 16 and the CPU executes the program stored in the memory.

Each of the storage systems 3 has a plurality of control units 310, a selection control unit 320, a plurality of disk devices 340, and a management control unit 350. Each of the control units 310 has a port as an interface for connection with the information processing apparatuses 1, 2, a CPU as a processor for controlling the access from the information processing apparatuses 1,2, and a memory. The selection control unit 320 selectively connects the control units 310 to the disk devices 340.

Thus, the data is stored in the disk device 340 specified from the control unit 310 and data is read out from the specified disk device 340. Moreover, the management control unit 350 has a CPU as a processor and a memory for collecting and managing performance information and state information on the storage systems 3. Furthermore, the management control unit 350 communicates with the management server 5 and defines the configuration of the storage systems 3.

The management server 5 is connected to the storage systems 3 and communicate with the management control unit 350 of the storage system for collecting the performance information and state information. Moreover, according to the storage allocation specification from the information processing apparatus 1, the management server 5 allocates a storage device of the storage systems 3 or reallocate the data stored in the storage systems 3.

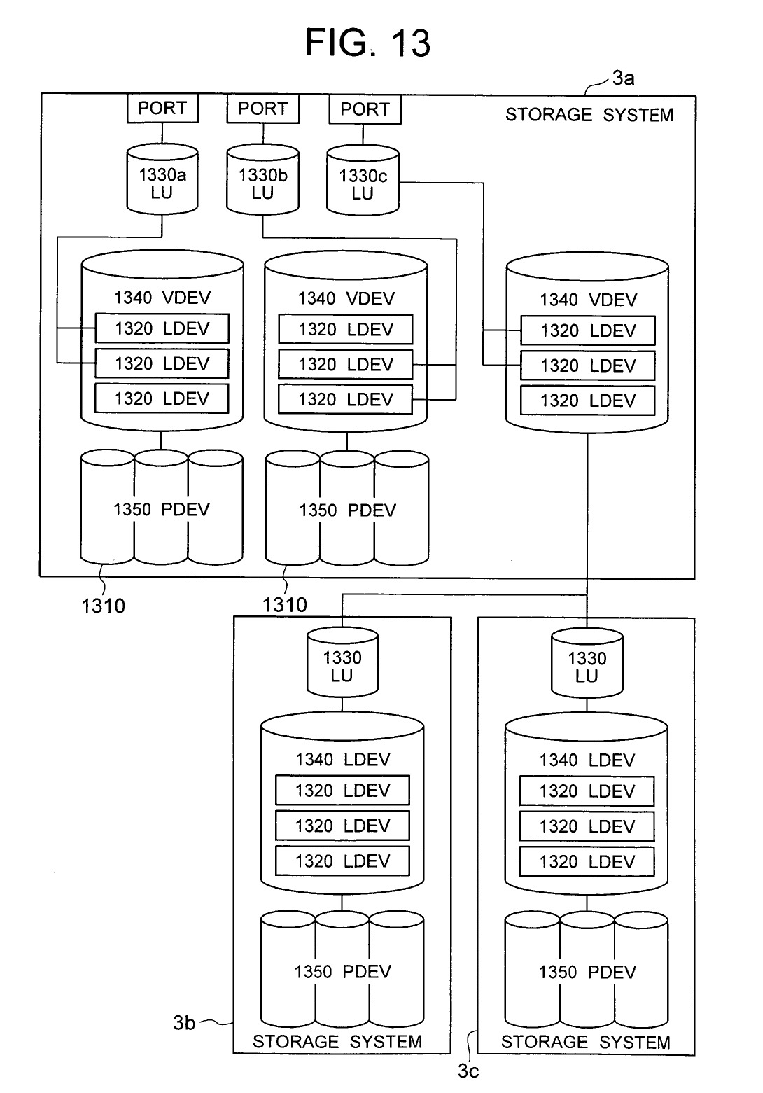

FIG. 13 explains the configuration of the storage systems 3 paying attention to the logical storage structure. The storage structure of the storage system 3a can be roughly divided into a physical storage hierarchy and a logical storage hierarchy. The physical storage hierarchy is formed by a PDEV (Physical Device) 1350 which is a physical disc. PDEV 1350 corresponds to a disk device 340.

The logical storage hierarchy can be configured by a plurality (for example, two types) of hierarchy. One logical hierarchy can be formed by a VDEV (Virtual Device) 1340. The other logical hierarchy can be formed by an LDEV (Logical device) 1320.

VDEV 1340 can be formed by grouping a predetermined number of PDEV 1350 such as a set of four pieces (3D+1P) or a set of eight pieces (7D+1P). The storage devices provided by the respective PDEV 1350 belonging to the group are collected to constitute one RAID storage device. The RAID storage device becomes a VDEV 1340.

Here, not all of VDEV 1340 are arranged directly on PDEV 1350 and some of VDEV 1340 can be generated as a virtually intermediate device. Such a virtual VDEV 1340 serves as a tray for mapping the LU (Logical Unit) 1330 of the storage systems 3b, 3c.

At least one LDEV 1320 can be arranged on VDEV 1340. LDEV 1320 can be formed by dividing VDEV 1340 into a fixed length. By mapping LDEV 1320 onto LU 1330, the information processing apparatuses 1, 2 recognize LDEV 1320 as one physical disk volume. By specifying the LUN (Logical Unit Number) as an identifier assigned for each LU 1330 and the logical block address, it is possible to access a desired LDEV 1320.

LU 1330 (1330a, 1330b, 1330c) are devices which can be recognized as SCSI logical units. Each of LU 1330 is connected to the information processing apparatuses 1, 2 via ports. Each of LU 1330 can be correlated to at least one LDEV 1320. By correlating one LU 1330 to a plurality of LDEV 1320, it is possible to virtually extend the size of LU 1330.

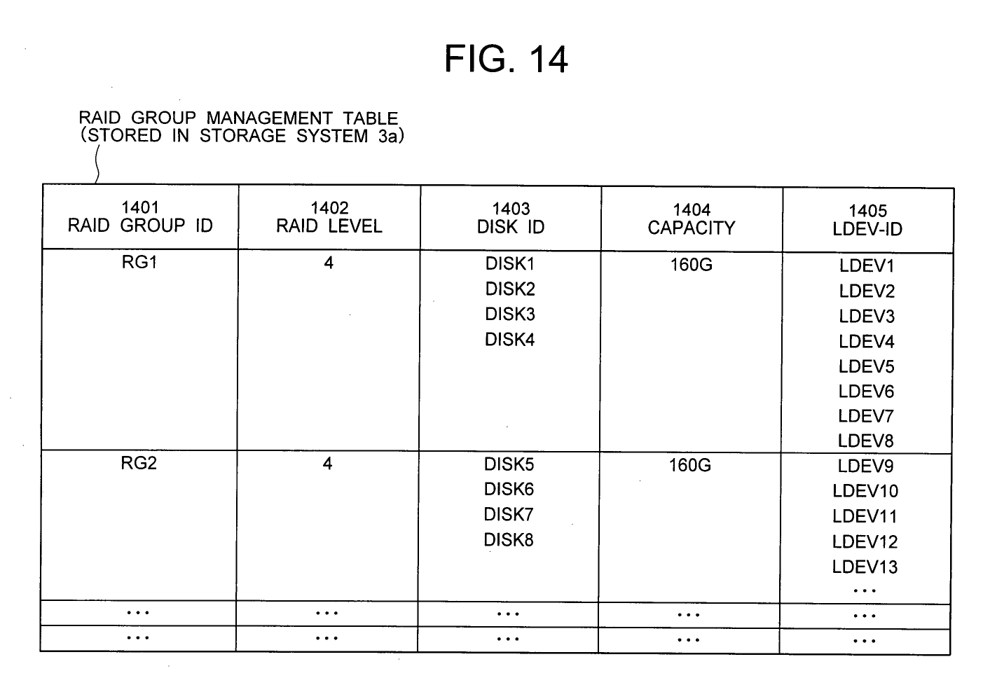

FIG. 14 shows an example of RAID group management table of one storage system 3. The RAID group management table is formed by a RAID group ID 1401 for identifying the RAID group, a RAID level 1402, a disk ID 1403 as an identifier of the disk device 340 constituting the RAID group, a RAID group capacity 1404, and an LDEV-ID 1405 for identifying LDEV 1320. The RAID group management table is stored in a memory of the management control unit 350 of each storage system 3.

Here LDEV 1320 is generated as follows. When the device management system 510 of the management server 5 reports a predetermined capacity to the management control unit 350 of the storage system 3, the CPU of the management control unit 350 generates an LDEV 1320 for a predetermined unit from the capacity of the RAID group.

For example, when the capacity of the RAID group is 40 [GB: Giga Byte] and the predetermined capacity sent from the management server is 5 [GB], eight (8=40 [GB]/5 [GB]) LDEV 1320 each having the capacity 5 are generated. A unique LDEV-ID in the storage system is attached to each of them and registered in the RAID group management table. The generation of the RAID group and generation of LDEV 1320 are performed as initialization of the storage system 3.

Next, explanation will be given on generation of LU 1330 and the process for making LU 1330 usable by the information processing apparatuses 1, 2. Firstly, it is necessary to generate an LU management table for utilizing LU 1330.

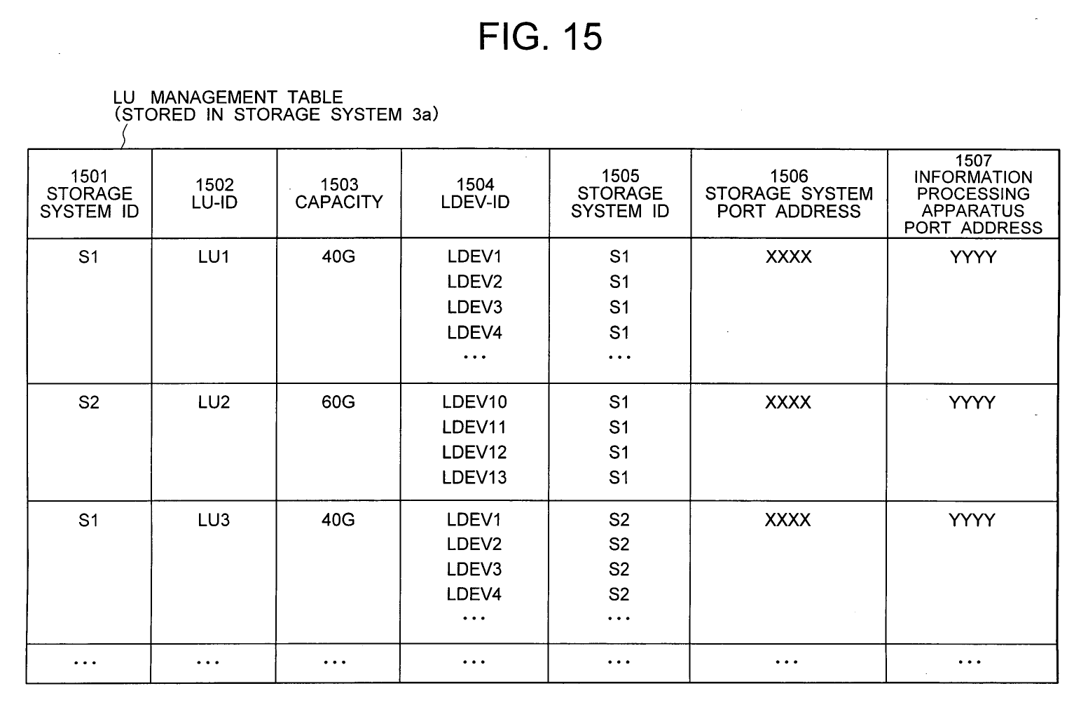

FIG. 15 shows an example of the LU management table in one storage system 3. The LU management table has a storage system ID 1501, an LU-ID 1502, a capacity 1503 of LU 1330, an LDEV-ID 1504, a storage system ID 1505, a storage system port address 1506, and an information processing apparatus port address 1507.

The storage system ID 1501 is an ID for identifying the storage system 3. LU 1330 is generated in the storage system 3 registered here. LU-ID 1502 is an ID assigned uniquely in each storage system. The capacity 1503 of LU 1330 is a total of the capacities of LDEV 1320 constituting LU 1330. LDEV-ID 1504 is an ID for identifying LDEV 1320 constituting LU 1330.

The storage system ID 1505 is an ID of the storage system 3 to which LDEV 1320 belongs. Accordingly, when the storage system 3 generating LU 1330 is different from the storage system 3 to which LDEV 1320 constituting LU 1330 belong, the storage system ID 1501 is different from the storage system ID 1505.

The storage system port address 1506 is an address of the port of the storage system 3 to which LU 1330 corresponds. The information processing apparatus port address 1507 identifies the information processing apparatuses 1, 2 which can use LU 1330. The information processing apparatuses 1, 2 having the port address can use LU 1330.

Next, explanation will be given on generation of the LU management table of FIG. 15.

Firstly, an administrator starts the device management system 510 and enters ID of the storage system 3 to instruct creation of an LU. Then, the device management system 510 generates an LU-ID unique in the storage system 3 and registers the storage system ID 1501 and LU-ID 1502 in the LU management table.

Next, the device management system 510 displays LDEV 1320 of each storage system 3 on the screen from the RAID group management table. When the administrator specifies the LDEV displayed on the screen and confirms it, LDEV-ID 1504 correlated to the ID of LU 1330 and selected and the storage system ID 1505 to which LDEV 1320 belongs are registered in the LU management table.

Next, the administrator registers the port address 1506 of the storage system and the port address 1507 of the information processing apparatus in the LU management table. It should be noted that registration of the port address may be performed by displaying the port of the storage system 3 and the ports of the information processing apparatuses 1, 2 on the screen and selecting the port, so that the address correlated to the port is registered in the LU management table.

The management server 5 sends the LU management table thus generated to each storage system 3. The management control unit 350 of the storage system 3 stores the LU management table in the memory. Next, the management control unit 350 sends LU-ID 1502, LDEV-ID 1504, the storage system ID 1505, the port address 1506 of the storage system, and the port address 1507 of the information processing apparatus to the control unit 310 having the port address 1506 of the storage system of the LU management table.

The control unit 310 correlates LDEV-ID 1504 to LU-ID 1502 and performs correlation of LU-ID 1502 for the port address 1506 of the storage system received. Thus, when LU 1330 is correlated to the port of the storage system 3, the information processing apparatuses 1, 2 can recognize LU 1330 which can be used.

That is, the information processing apparatuses 1, 2 send an inquiry command including a port address 1507 of the information processing apparatus and a port address 1506 of the storage system to the storage system 3. When the control unit 310 of the storage system 3 receives an inquiry command in the port of the storage system managed by itself, it compares the port address 1507 of the information processing apparatus to the port address 1507 of the information processing apparatus managed by the control unit 310. When the port address coincide, the control unit 310 sends the ID of LU 1330 correlated to the port of the storage system 3 to the information processing devices 1, 2. Thus, the information processing apparatuses 1, 2 can know LU 1330 which can be used.

Moreover, when an access request is made from the information processing apparatuses 1, 2, the control unit 310 specifies LDEV 1320 according to LU-ID 1502 contained in the access request and writes or read data to/from the disk device 340 correlated to LDEV 1320 specified. Here, when LDEV 1320 correlated to LU 1330 is a different storage system 3, the control unit 310 sends an access request to the storage system 3 to which LDEV 1320 belongs and data is written or read to/from the disk device 340 correlated to LDEV 1320.

In this configuration, explanation will be given on the method for allocating the storage device explained in S203 of FIG. 9.

Here, explanation will be given on the method for referencing the performance information on the storage system 3, LU 1330, and LDEV 1320 and performing allocation according to the performance information. The management control unit 350 of each storage system 3 collects and manages the performance information of the storage system 3.

The performance information on the storage system 3 includes static information such as the capacity of the entire storage system and the type of the disk device 340 and dynamic performance such as power consumption of the storage system 3, frequency of access to the port, frequency of access to LU 1330, frequency of access to LDEV 1320, frequency of access to the disk device 340, and response time.

Here, the response time is a time from the moment when a data read or write request is issued to the disk device 340 by the control unit 310 to the moment when the response is returned. In general, response is faster in access to the disk device 340 of the local storage system 3 than in access to the disk device 340 of another storage system 3.

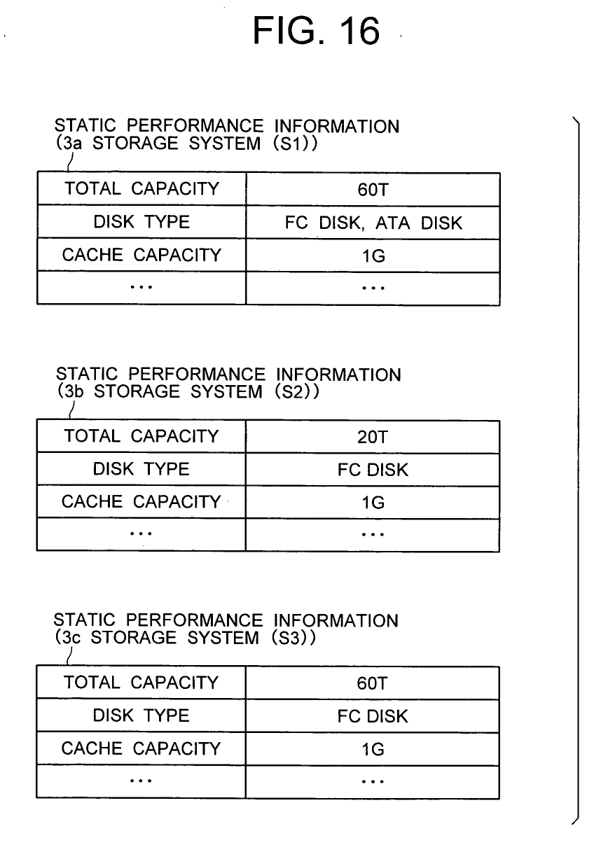

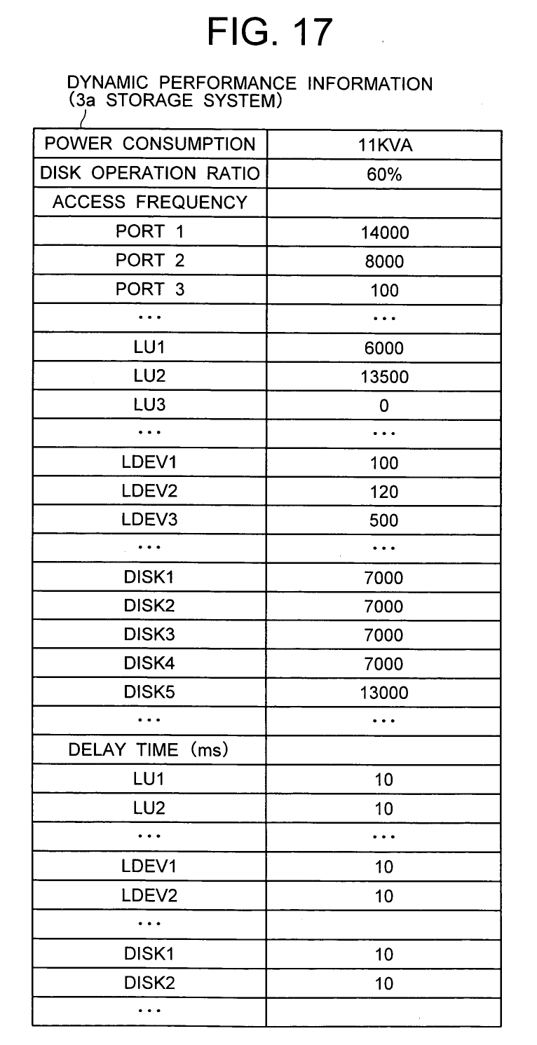

FIG. 16 shows an example of static performance information. FIG. 17 shows an example of dynamic performance information. The dynamic information is collected at every one hour.

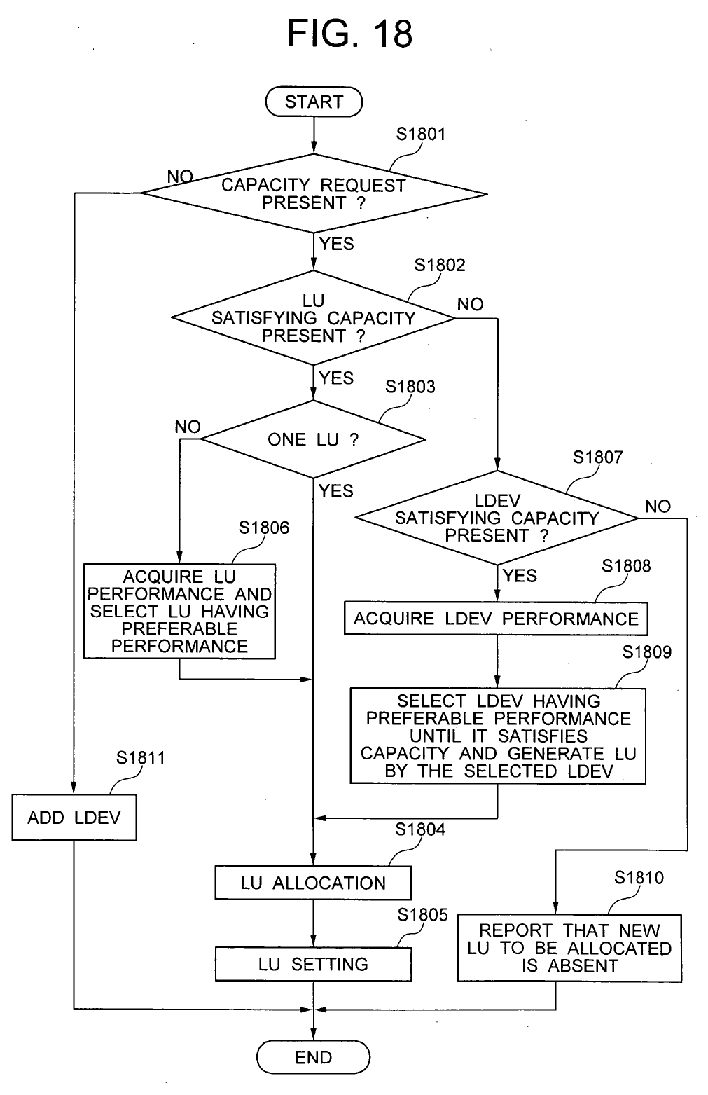

FIG. 18 shows a processing of the storage allocation unit 52. Explanation will be given on the processing of the storage allocation unit 52. Firstly, before performing this processing, an LU 1330 not allocated to a port is prepared. That is, in the LU management table shown in FIG. 15, there is prepared in advance an LU 1330 having the port address 1506 of the storage system and the port address 1507 of the information processing apparatus not registered. This is identical to reservation of LDEV 1320 for utilizing some LDEV 1320.

Upon reception of storage allocation, the storage allocation unit 52 judges whether the request includes a capacity (S1801). If the capacity is included (YES in S1801), the LU management table is read out from the management control unit 350 of each storage system 3 and LU 1330 satisfying the capacity included in the setting request is searched (S1802).

When there is an LU 1330 which satisfies the capacity contained in the setting request (YES in S1802) and only one LU 1330 satisfies the capacity (YES in S1803), an allocation process of LU 1330 is executed so that LU 1330 is allocated to be used (S1804). This allocation sets the port address 1507 of the information processing apparatus for the selected LU 1330 and the port address 1506 of the storage system in the LU management table.

The port address 1507 of the information processing apparatus is registered for each of the information processing apparatuses 1, 2 in the management server 5. The port address can be identified from the ID of the information processing apparatuses 1, 2 requested. Moreover, the port address 1506 of the storage system is decided by referencing the performance information so that the frequency of the access of the port is small. That is, by referencing the port access frequency, the port having the smallest access frequency is decided.

LU 1330 thus allocated is reported to the storage system 3 and the information processing apparatuses 1, 2 and setting of LU 1330 is performed (Sl805). That is, by sending the allocated LU management table to the storage system, the storage system 3 performs setting of LU 1330. Moreover, by sending the allocated LU-ID and capacity to the information processing apparatuses 1, 2 requested, the information processing apparatuses, 1, 2 register the ID of LU 1330 corresponding to the area in the area information table 64 and add the capacity of the area to the area management information 66.

It should be noted that when more than one LU 1330 satisfy the capacity (NO in S1803), the storage allocation unit 52 obtains the performance of each LU 1330 and selects one LU 1330 having the highest performance (S1806).

The performance of each LU 1330 is acquired as follows. As has been explained above, a plurality of LDEV 1320 are formed for the disk device 340 and the LDEV 1320 are selected to form the LU 1330. Accordingly, there is a case that a plurality of LU 1330 share the disk device 340.

In this case, an unallocated LU 1330 sharing the disk device 340 with the LU 1330 having a high access frequency and an unallocated LU 1330 sharing the disk device 340 with the LU 1330 having a low access frequency have different performances. Here, according to another LU 1330 sharing the disk device 340 with the unallocated LU 1330, it is determined how much the unallocated LU 1330 is affected. Thus, the unallocated LU 1330 having a small affect from the another LU 1330 is determined.

In order to realize this, firstly, the storage allocation unit 52 reads out the performance information and the RAID group management table from the management control unit 350 of the storage system 3. Next, LDEV 1320 constituting the unallocated LU 1330 determined in S1802 is identified from the LU management table.

Tentatively, when LU 2 in FIG. 15 is unallocated (the port address 1506 of the storage system and the port address 1507 of the information processing apparatus are unallocated), LDEV 13 is identified from LDEV 10. Next, the disk device 340 allocated to LDEV 1320 is identified from the RAID group management table and the access frequency of the disk device 340 is determined from the performance information. Since LDEV 10 to LDEV 13 are formed by DISK 5 to DISK 6, the access frequency of DISK 6 is determined from DISK 5 and this is used as the affect degree.

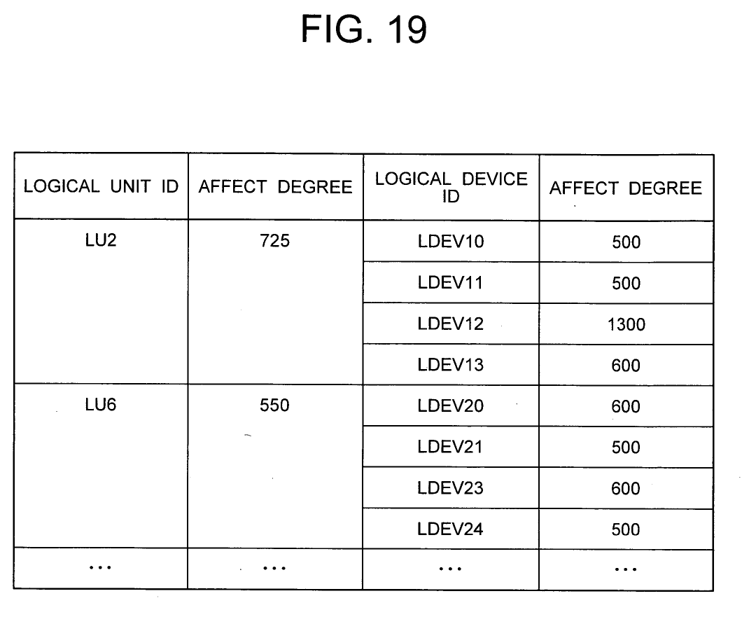

If there are irregularities in the access frequency of DISK 5 to DISK 6, the one having the largest access frequency is identified as an affect degree of LDEV 1320. Thus, the affect degree of each LDEV 1320 is determined as shown in FIG. 19. As the affect degree of LDEV 1320 decreases, the performance of LDEV 1320 is improved. Next, for each LU 1330, the average of the affect degree of LDEV 1320 is determined. And the one having the smaller average is identified as LU 1330 to be allocated.

The allocation processing of LU 1330 is executed (S1804) so that LU 1330 thus identified can be utilized and the setting of LU 1330 is executed (S1805).

On the other hand, when no LU 1330 satisfying the requested capacity is prepared upon reception of the setting request (NO in S1802), the storage allocation unit 52 generates a new LU 1330 to be allocated. Firstly, according to LDEV 1320 (LDEV 1320 not used and not reserved) not allocated for LU 1330, it is judged whether the requested capacity is satisfied (S1807). That is, it is judged whether the total of the capacities of the unallocated LDEV 1320 reaches the requested capacity.

Here, when the total does not reach the requested capacity (NO in S1807), LU 1330 of the requested capacity cannot be generated and it is reported to the information processing apparatuses 1, 2 that no LU 1330 to be allocated is present (S1810).

On the other hand, when the total reaches the requested capacity (YES in S1807), the performance of the unallocated LDEV 1320 is determined (S1808). That is, the affect degree of the logical device not allocated to LU 1330 is determined from the performance information and the RAID group management table.

Next, an LDEV 1320 having a preferable performance is selected until it satisfies the requested capacity and LU 1330 is generated by the selected LDEV 1320 (S1809). That is, selection is started from LDEV 1320 having a smaller affect degree and continued until the requested capacity is satisfied. When the requested capacity is satisfied, the storage allocation unit 52 terminates selection of LDEV 1320, registers the selected LDEV 1320 in the LU management table, and registers the ID of LU 1330.

The allocation processing of LU 1330 is executed so that LU 1330 thus generated can be used (S1804) and the setting of LU 1330 is executed (S1805).

Thus, the storage allocation unit 52 can allocate a new LU 1330 according to a request from the information processing apparatuses 1, 2. Moreover, the storage allocation unit can also extend the existing LU 1330. For example, when the capacity request is not performed (NO in S1801), the storage allocation device 52 acquires the performance of LDEV 1320 and allocates LDEV 1320 having a preferable performance additionally to the existing LU 1330 (S1811).

In this case, by reporting the ID of LU 1330 to be extended from the information processing apparatuses 1, 2 to the storage allocation unit 52, the storage allocation unit 52 can additionally register LDEV 1320 to LU 1330 reported. Thus, it is possible to easily add the capacity of the existing LU 1330.

This is effective when the capacity predicted in the information processing apparatuses 1, 2 is smaller than the capacity actually used. That is, when the capacity of LU 1330 becomes not sufficient during use, a new LU 1330 is generated, data in the old LU 1330 is all copied to the new LU 1330, and then data is written. However, according to the present embodiment, since LDEV is added, the copying of the old LU 1330 is not necessary. According to the request from the information processing apparatuses 1, 2, a necessary capacity can be provided.

It should be noted that the dynamic performance information used in the storage allocation device 52 may be performance information only for a predetermined time or an average value of the day.

Next, explanation will be given on the area operation modification shown in S105 of FIG. 7 or S206 of FIG. 9.

Data has a life cycle. The data may be accessed often for a certain period of time but currently not accessed at all or rarely accessed. When there is a performance difference between a plurality of storage systems 3, the entire system may be effectively operated if it is possible to identify a storage system 3 performing storage by using the data access frequency so as to effectively use the storage system 3.

Here, explanation will be given on a case when data of low access frequency is stored into a storage system 3 having a lower performance.

Firstly, data to be moved is identified. The identification of data to be moved is performed as follows. Firstly, as shown in FIG. 5B, when the data area is correlated to the index area, the data area correlated to the deleted index area is made an object to be moved. This can be realized by a program by monitoring the table division definition table 62.

Moreover, in the table division condition shown in FIG. 5B, data of a predetermined date and before is made an object to be moved. Thus, the data to be moved is identified. The area information table 64 is referenced and LU 1330 containing the data to be moved is identified. LU 1330 to be moved is reported tot he management server 5. This can also be realized by the program.

Thus, the movement of the data in LU 1330 reported to the management server 5 is entrusted to the management server 5. That is, a movement candidate is reported to the management server 5 from the information processing apparatuses 1, 2 and the management server 5 judges the movement timing for performing movement of the data. The management server 5 receives the report of LU 1330 to be moved and executes the data reallocation program.

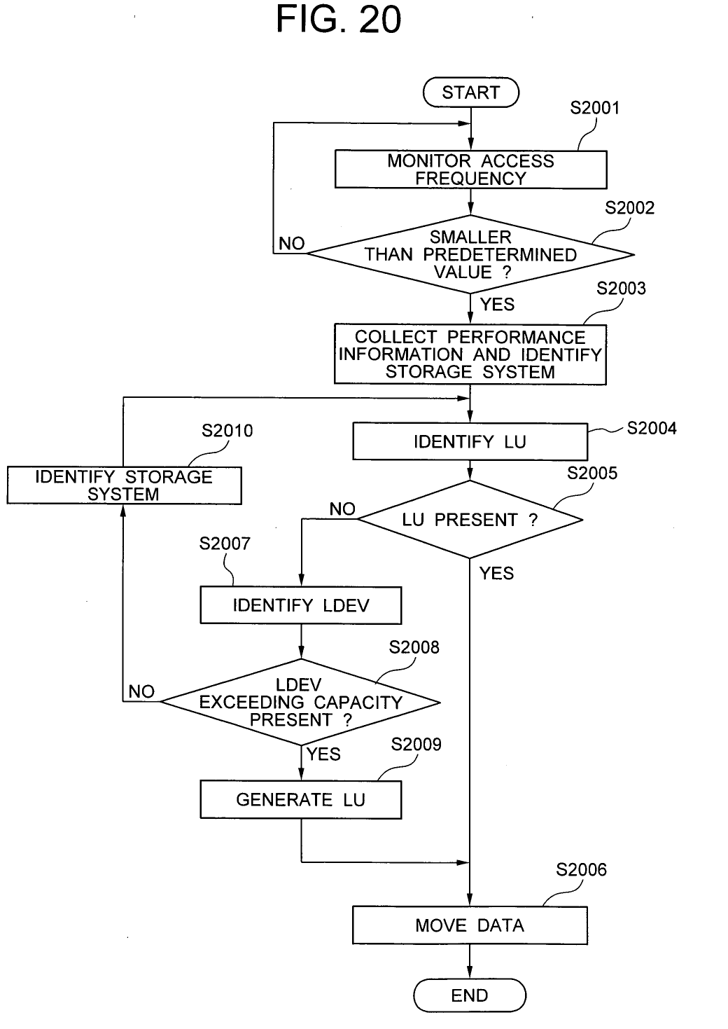

FIG. 20 shows processes executed by the data reallocation program. Hereinafter, the data reallocation program is executed by the CPU, thereby realizing the data reallocation unit 520.

The data reallocation unit 520 monitors the access frequency of LU 1330 to be moved (S2001). Thus, performance information is collected from the management control unit 350 of the storage system 3 to which LU 1330 belongs so as to judge whether the access frequency of LU 1330 is not greater than a predetermined value. While the access frequency is not smaller than the predetermined value (NO in S2002), monitoring of the access frequency is continued.

When the access frequency of LU 1330 has become a predetermined value or below (YES in S2002), the a process is executed to identify LU 1330 as the destination of movement of the data stored in LU 1330. Firstly, the data reallocation unit 520 collects performance information from the storage system 3 and identifies the storage system 3 as the movement destination (S2003).

Since the data to be moved has a low access frequency, it is considered to use the storage system 3 not requiring cost to store the data. For example, a storage system 3 requiring low power consumption, a storage system 3 having a small total capacity, or a storage system 3 having a low disk operation ratio can be considered as a storage system 3 not requiring the cost or the storage system itself is cheap.

The data reallocation unit 520 obtains an evaluation value of each storage system 3 by using the performance information on the storage system 3 collected as an evaluation item. The evaluation value S is acquired by a polynomial K1·H1+K2·H2+K3·H3 . . . (Kn is an evaluation coefficient, and Hn is an evaluation item value).

For example, when H1 is a power consumption, H2 is a total capacity, H3 is an operation ratio, and K1=1, K2=K3=0, then the evaluation value is determined by the power consumption. It should be noted that Kn is determined by the administrator. For example, when the evaluation value is determined by the power consumption, a storage system 3 having a small evaluation value is specified. The evaluation item may be static performance information or the dynamic storage system 3.

Next, the data reallocation unit 520 specifies an LU 1330 (S2004). For specifying LU 1330, the data reallocation unit 520 searches LU 1330 having the RAID level 1402 identical to LU 1330 as the movement source and a capacity not smaller than the LU as the movement source by using the RAID group management table and the LU management table.

When LU 1330 is found (YES in S2005), data is moved to LU 1330 as LU 1330 as the movement destination (S2006), thereby terminating the process. On the other hand, if no LU 1330 is found (NO in S2005), it is judged whether it is possible to generate an LU 1330. Firstly, an LDEV 1320 of the RAID level 1402 identical to LU 1330 of the movement source and not constituting LU 1330 from the RAID group management table and the LU management table (S2007).

It is judged whether the total capacity of the identified LDEV 1320 reaches the capacity of LU 1330 of the movement source (S2008). If the total capacity reaches the capacity of LU 1330 of the movement source (YES in S2008), an LDEV 1320 satisfying the capacity of LU 1330 of the movement source is selected, an LU 1330 is generated (S2009), and the data is moved there (S2006). Here, if the capacity does not reach the capacity of LU 1330 of the movement source (NO in S2008), it is judged that the storage system 3 does not have LU 1330 of the movement destination, a storage system 3 of the next great evaluation value is selected (S2010), and control is returned to S2004.

It should be noted that if the access frequency to the data is again increased, or the index is created, it is necessary to move the data to an LU 1330 having a higher response speed. In this case, by selecting the storage system 3 having a large evaluation value of the performance information obtained in S2003, it is possible to select a storage system 3 of a high performance.

Moreover, in the identification of LU 1330 in S2004 and in identification of LDEV 1320 in S2007, as has been explained in FIG. 19, the affect degree of LDEV 1320 is obtained. By selecting LU 1330 and LDEV 1320 of a small affect degree, it is possible to acquire an LU 1330 of a higher performance.

It should be noted that the storage system 3 has been identified according to the performance information. The administrator evaluates the performance of each storage system 3 in advance and ranks the storage systems 3 in the descending order of the performance, which is registered as the evaluation result in the management server 5. When selecting a storage system 3, the rank as the evaluation result can be referenced to decide the selection.

Moreover, when S1810 judges that no LU 1330b to be allocated is present, the data of LU 1330 which is a movement candidate is moved to the management server 5 and LU 1330 can be made as the new LU 1330 to be allocated. That is, the data reallocation unit 520 of the management server 5 receives a report that no LU 1330 to be allocated is present from the storage allocation unit 52 and specifies an LU 1330 satisfying a necessary capacity from LU 1330 made as a movement candidate. The data of the specified LU 1330 is moved according to the FIG. 20. When movement of the data is complete, the data of the specified LU 1330 is deleted and LU 1330 is made a new LU 1330 to be allocated.

It should be further understood by those skilled in the art that although the foregoing description has been made on embodiments of the invention, the invention is not limited thereto and various changes and modifications may be made without departing from the spirit of the invention and the scope of the appended claims.

1. A storing-into-database method for storing a database table into a storage device as a physical storage medium, the method executed by an information processing apparatus comprising the steps of:
dividing the database table into separate tables according to a table division condition, correlating the separate tables with areas as logical storage devices, and correlating the areas with the storage devices;
detecting a predetermined area whose use amount is equal to or exceeds a predetermined value;
assuring an empty storage device having an empty capacity; and
adding the empty storage device to the storage device correlated to the predetermined area.

2. The method as claimed in claim 1, wherein an area type of at least one of a data area, an index area and an object area is assigned to the area and according to the area type, the area is correlated to the storage device.

3. The method as claimed in claim 1, wherein the step of detecting that the use amount of the area is equal to or exceeds the predetermined value is executed during data write.

4. The method as claimed in claim 2, wherein the step of detecting that the use amount of the area is equal to or exceeds the predetermined value is executed during data write.

5. The method as claimed in claim 1, wherein operation is modified for the empty storage device and another storage correlated to the predetermined area.

6. The method as claimed in claim 2, wherein operation is modified for the empty storage device and another storage correlated to the predetermined area.

7. The method as claimed in claim 3, wherein operation is modified for the empty storage device and another storage correlated to the predetermined area.

8. The method as claimed in claim 4, wherein operation is modified for the empty storage device and another storage correlated to the predetermined area.

9. A storing-into-database method for storing a database table into a storage device as a physical storage medium, the method executed by an information processing apparatus comprising the steps of:
dividing the database table into separate tables according to a table division condition, correlating the separate tables with areas as logical storage devices, and correlating the areas with the storage devices;
detecting a first area whose use amount is equal to or exceeds a predetermined value;
assuring an empty storage device having an empty capacity;
modifying the table division condition concerning the first area division table and a division table of a second area in the area; and
adding the empty storage device to the storage device correlated to the second area.

10. The method as claimed in claim 9, wherein a area type of at least one of a data area, an index area and an object area is assigned to the area and according tot the area type, the area is correlated to the storage device.

11. The method as claimed in claim 9, wherein the step of detecting that the use amount of the area is equal to or exceeds the predetermined value is executed during data write.

12. The method as claimed in claim 10, wherein the step of detecting that the use amount of the area is equal to or exceeds the predetermined value is executed during data write.

13. The method as claimed in claim 9, wherein operation is modified for the empty storage device and another storage device correlated to the first area.

14. The method as claimed in claim 10, wherein operation is modified for the empty storage device and another storage device correlated to the first area.

15. The method as claimed in claim 11, wherein operation is modified for the empty storage device and another storage device correlated to the first area.

16. The method as claimed in claim 12, wherein operation is modified for the empty storage device and another storage device correlated to the first area.

17. A database storing system comprising an information processing apparatus for storing a database table into a storage device as a physical storage medium, wherein:
the information processing apparatus divides the database table into separate tables according to a table division condition, correlates the separate tables with areas as logical storage areas, and correlates the areas with the storage areas, and
the information processing apparatus includes:
an area monitoring unit for detecting a predetermined area whose use amount is equal to or exceeds a predetermined value;
a processing request execution unit for assuring an empty storage device having an empty capacity; and
an area allocation unit for adding the empty storage device to the storage device correlated to the predetermined area.

18. A database storing system comprising an information processing apparatus for storing a database table into a storage device as a physical storage medium, wherein:
the information processing apparatus divides the database table into separate tables according to a table division condition, correlates the separate tables with areas as logical storage areas, and correlates the areas with the storage devices, and the information processing apparatus includes:
an area monitoring unit for detecting a first area whose use amount of the area is equal to or exceeds a predetermined value;
a processing request execution unit for assuring an empty storage device having an empty capacity;
a table division definition modification unit for modifying the table division condition concerning the division table of first area and a division table of a second area in the area; and
an area allocation unit for adding the empty storage device to the storage device correlated to the second area.
